(19) United States
(12) Patent Application Publication
(10) Pub. No.: US 2024/0004777 A1
(43) Pub. Date: Jan. 4, 2024

(54) EXTENSIBLE FRAMEWORK FOR AUTOMATIC COMPLEX SYSTEMS DIAGNOSTICS

(71) Applicant: Microsoft Technology Licensing, LLC, Redmond, WA (US)

(72) Inventors: Kamran Seyed REYPOUR, Kirkland, WA (US); Khoa Anh TO, Redmond, WA (US); Kusuma SRINIVASA MURTHY, Redmond, WA (US); Thomas Michael XANTHOS, III, Redmond, WA (US)

(21) Appl. No.: 18/116,165

(22) Filed: Mar. 1, 2023

Related U.S. Application Data
(60) Provisional application No. 63/357,423, filed on Jun. 30, 2022.

(51) Int. Cl. G06F 11/34; G06F 9/445; G06F 11/16

(52) U.S. Cl. CPC G06F 11/3466; G06F 9/44505; G06F 11/16

(57) ABSTRACT

A method includes obtaining a trace file, obtaining a configuration file, identifying a scenario in the configuration file, implementing a state machine for the scenario, iterating the state machine through the scenario based at least partially on values obtained from the trace file, identifying a log event in the trace file based on the state machine, and reporting a state machine result of the log event.

### RELATED APPLICATIONS

The present application claims priority to and the benefits of U.S. Provisional Patent Application No. 63/357,423 entitled “EXTENSIBLE FRAMEWORK FOR AUTOMATIC COMPLEX SYSTEMS DIAGNOSTICS” and filed Jun. 30, 2022, the disclosure of which is incorporated herein by reference in its entirety.

### BACKGROUND

### Background and Relevant Art

Complex components such as operating system kernel-mode components perform scenario operations consisting of many subtasks. When troubleshooting an issue, technical staff must go through the component traces and identify that each scenario is completed successfully. Such troubleshooting requires extensive knowledge of each scenario and associated subtasks; hence, doing the root cause analysis of an issue is a manual process that is conventionally performed by highly trained staff.

### BRIEF SUMMARY

In some embodiments, a method includes obtaining a trace file, obtaining a configuration file, identifying a scenario in the configuration file, implementing a state machine for the scenario, iterating the state machine through the scenario based at least partially on values obtained from the trace file, identifying a log event in the trace file based on the state machine, and reporting a state machine result of the log event.

In some embodiments, a system includes a processor and a non-transitory computer readable media (CRM). The CRM includes instructions stored thereon. The instructions, when executed by a processor, cause the system to obtain a trace file, obtain a configuration file, identify a first scenario in the configuration file including a first plurality of subtasks, implement a first state machine for the first scenario, iterating the state machine through the first scenario based at least partially on the trace file, exceed a timeout value associated with the first scenario, identifying a second scenario including a second plurality of subtasks, implement a second state machine for the second scenario, and report a timeout event for at least one subtask of the second plurality of subtasks of the second state machine.

In some embodiments, a non-transitory CRM includes instructions stored thereon. The instructions, when executed by a processor, cause the processor to obtain a trace file, obtain a configuration file, identify a scenario in the configuration file, implement a state machine for the scenario, iterate the state machine through the scenario based at least partially on values obtained from the trace file, identify a log event in the trace file based on the state machine, and report a state machine result of the log event.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a flowchart illustrating a method of automatically diagnosing a complex system, according to at least some embodiments of the present disclosure;

FIG. 2 is a schematic representation of an extensible framework, according to at least some embodiments of the present disclosure;

FIG. 3 is an example configuration file including a scenario, according to at least some embodiments of the present disclosure;

FIG. 4 is an example configuration file including an invalid scenario, according to at least some embodiments of the present disclosure; and

FIG. 5 is an example configuration file including a valid scenario, according to at least some embodiments of the present disclosure.

### DETAILED DESCRIPTION

The present disclosure generally relates to systems and methods for automatic diagnosis of complex computer systems. More particularly, the present disclosure relates to an extensible framework to diagnosis a failure or timeout of one or more subtasks within a complex system. For example, complex components and/or systems such as kernel-mode components perform scenario operations that include many subtasks, which are either sequentially performed and dependent on one another or concurrently performed and independent of one another. Such complex scenario operations can be difficult or nearly impossible to diagnose in real-time as identifying the individual subtask success or failure cannot be performed in real-time.

In some embodiments, the computing system generates a trace file for the scenario and/or component including the scenario. The scenario and/or component including the scenario includes one or more tasks for the computing system to perform. The trace file is generated by the computing system upon a failure of a task (or subtask of a task) of the scenario, and the trace file can include records of thousands of operations, threads, or other computational functions that, while reporting the results of the scenarios and subtasks, can obfuscate the outputs. Further, the trace files can include all operations performed by the system, which may include a variety of types of operations (network communication, virtual machine implementation, hardware controllers, etc.) and/or log events for operations in a non-linear order, impairing the ability for any single user, such as an engineer, service specialist, technician, customer, etc. to interpret all of the different operation types and subtasks associated with a scenario. An extensible framework according to the present disclosure provides an automated tool for identifying a failure of a subtask within a scenario of a complex system, reporting the failure in a human-readable format, and, in some embodiments, directing a report to an appropriate engineer or engineering group.

In a conventional simple system within a computing system without concurrent or parallel processes, a failure or one or more events of the simple system is logged in one or more lines of an event log. Diagnosing the event may include reading the event log to identify the point in the simple system that caused the failure. In a complex system, parallel operations and complex interactions between scenarios and subtasks can produce a trace file that, while including a record of the failed or incomplete operation, may be not readable or understandable to a user. For example, during virtual machine creation in a datacenter, many systems are operating in parallel to establish both software and hardware controls. An operation failure during the virtual machine creation may be difficult or impossible to identify and a user may be unable to diagnose a root cause of the failure using existing diagnostic tools. Further, in some instances, analysis of and/or diagnosis of some operating systems or other low-level complex systems require kernel mode and/or are non-extensible, limiting the scalability and deployability of new scenarios and new diagnostic tools.

In some embodiments, an extensible framework for automatic complex system diagnostics according to the present disclosure is a framework that reads one or more configuration files (“config files”) which describe different scenarios as decision trees of trace events recorded in a trace file. The framework implements one or more state machines based on the scenario(s) of the config file and preset variables. The state machine(s) then parse the trace file to match variables with the trace events of the trace file. Matching variables with the trace events of the trace file can allow the state machines to iterate through the subtasks of the scenario and identify the root cause of the failure.

For example, if Trace Event A is detected in the trace file for Scenario A′ then the framework expects events B through N to have occurred and be present in the trace file for Scenario A′ to be successful. The framework will iterate through the expected events of the scenario (based at least partially on the config file) in an attempt to match identifying values for the expected events of the scenario. In the instance that the framework is unable to match identifying values for the expected events of the scenario, the framework returns an error for the scenario and/or identify which subtask event caused the failure. In some examples, the framework identifies explicit errors in the trace file for the trace events associated with the identifying values. In such examples, the framework returns an error for the scenario and/or identifies which subtask event caused the failure. For example, a report is provided, where the report indicates the scenario or subtask associated with the failure. Thereby, a user is directly informed that a certain subtask or scenario has failed or not been executed.

In some embodiments, the config file is a human-readable structured file. In some examples, a human-readable structured file allows a user to add new entries to the config file as issues arise and are identified, or as new features are added to components of the system. Because the framework receives scenarios and implements state machines based at least partially on the config file, different config files allow the framework to be adapted to a variety of diagnostic needs for a variety of systems. Embodiments of config files described herein will provide examples of specific diagnostic needs but should be understood as examples.

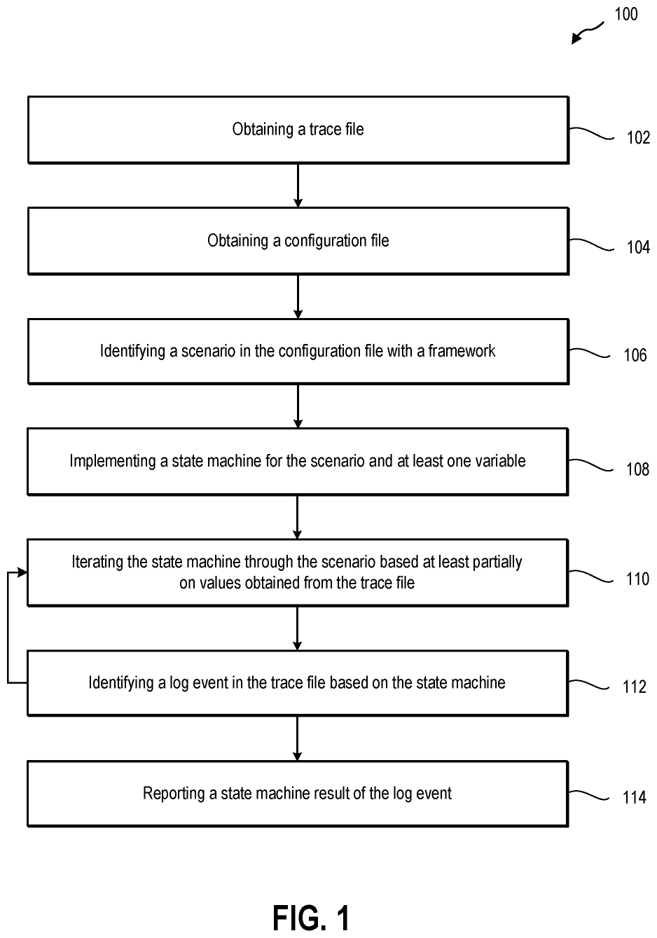

FIG. 1 is a flowchart illustrating a method 100 of providing a framework for automated diagnosis of a complex system. The method 100 includes obtaining a trace file at 102 and obtaining a config file at 104. In some embodiments, the framework is provided by or within an operating system of a computing device. In some embodiments, the framework is stored locally on a hardware storage device on the computing device. In some embodiments, the framework is obtained by the computing device from a remote hardware storage device, such as via a network.

The trace file is, in some embodiments, generated by the application, the operating system, or another complex system to report one or more failed or incomplete tasks. For example, upon a request failing or generating an error, a user is presented with the trace file to diagnose the error. In some embodiments, the trace file is generated independently of whether there was a failed or incomplete task. In at least one embodiment, the trace file is a plain text file, which is able to be parsed through regular expressions (regex). For example, the trace file is a onetrace.txt file, and the regex parsing allows the framework to identify strings within the onetrace.txt file based on the config file obtained at 104.

In some embodiments, the user provides a config file to the framework, such as in a console command, and the config file is stored locally on a hardware storage device on the computing device. In some embodiments, the config file is obtained by the computing device from a remote hardware storage device, such as via a network. The config file provided to the framework is, in some embodiments, related to the error that caused the trace file. In other embodiments, the config file instructs the framework to identify values for variables based on the trace file and events therein to diagnose the failed subtasks of the scenario.

In some embodiments, the config file is written in a human-readable structure, such as Yet Another Markup Language (“YAML”). A human-readable language and/or structure allows the config file to be customized, modified, or simply understood by a technician or other user. For example, the config file includes comments therein to inform a user of operations performed by or requested by the config file.

The method 100 further includes identifying a scenario in the configuration file with the framework at 106. A scenario is an operation of the computing device (e.g., of the operation system, subsystem, or application stored thereon) that includes a plurality of subtasks managed or coordinated by the scenario. In some embodiments, the framework reads the config file to identify at least one scenario in the config file. In some embodiments, the config file includes a plurality of scenarios. In some embodiments, one or more of the scenarios is enabled upon initial reading of the config file, and, in some embodiments, one or more of the scenarios is disabled upon initial reading of the config file. In some embodiments, during execution of the config file by the framework, a scenario that is initially disabled is enabled based upon the results of another scenario. For example, if a first scenario produces a particular output, a second scenario is enabled, and the framework performs at least a portion of the second scenario in response to the output of the first scenario. In at least one example, if a first scenario exceeds a timeout value, the second scenario is enabled in response to the first scenario timing out.

The method 100 further includes implementing at least one state machine based at least partially on the at least one scenario and at least one variable at 108. In some embodiments, implementing the framework includes creating one or more state machines based on the scenario and initial variables. For example, the framework defines one or more variables and read preset values for the one or more variables. In some embodiments, a user provides the preset values for the one or more variables, and the framework reads the preset values to populate at least a portion of the state machines from the scenario.

In some embodiments, the framework defines one or more of the state machine(s) as active state machines. Any state machines are defined as active until the state machine completes the scenario, either through a success, a failure, a restart, or another complete state. When the state machine completes the scenario, in some embodiments, the framework defines the state machine as finished and remove the state machine from the active state machines definition. In some embodiments, a state machine will remain active if the state machine is unable to complete the scenario for any reason.

In some embodiments, a variable is a globally unique identifier (GUID) that the user provides to at least partially identify the failed request or scenario the user desires to diagnose. In some embodiments, the variable has no assigned value upon defining the variable, and the value is assigned upon executing at least a portion of a state machine. In some embodiments, the variable is a preset variable with a value that is assigned upon defining the variable. For example, a preset variable is or includes a correlation ID that is provided for operations or processes of some complex systems. In some examples, a correlation ID is a unique identifier that is added to a first interaction (incoming request) to identify the context and is passed to all components that are involved in a transaction flow. In a particular example, some complex systems such as MICROSOFT SHAREPOINT or MICROSOFT AZURE, virtual machine operations automatically provide a correlation ID that is a GUID for every request that the server receives. In some embodiments, the correlation ID is unique to each request. When an error occurs related to the request, some embodiments of an error message contain the correlation ID that was valid for the request at the time, which is, in some embodiments, provided to the framework, and the framework uses in the scenario to identify event logs in the trace file associated with the request that generated the error and/or other processes that were occurring at the time of the error. It should be understood that the correlation ID is any tool used to associate events within the complex system. In some embodiments, a correlation ID is a ThreadID, ProcessID, timestamp, CorrelationID, or other function within the system.

The method 100 further includes iterating the state machine through the scenario based at least partially on the trace file at 110. In some embodiments, the framework is implemented by defining variables that do not have values upon initialization. In some embodiments, the framework initializes the state machine based at least partially on the config file and the preset variables. The config file includes a scenario with a plurality of subtasks therein. The state machine iterates through the subtasks of the scenario by parsing the trace file and matching the events identified in the scenario. As described herein, a scenario includes an expected sequence of events and/or subtasks to be performed and, therefore, recorded in the trace file. In some embodiments, the scenario includes regex commands or other parsing and/or matching commands to identify events in the trace file.

In some embodiments, the framework identifies a new value for a variable in the scenario and uses that new value in a subsequent subtask of the scenario. As will be described herein, in some embodiments, each event of a scenario identifies a variable that is associated with an immediately subsequent event, ensuring continuity of the events through the scenario for diagnostics.

As the framework implements state machines and iterates through the scenarios, in some embodiments, the framework provides sequential scenarios for diagnosing failed scenarios. In other embodiments, the framework provides parallel scenarios in the framework to allow simultaneous operations where a first scenario is independent of the output or results of a second scenario.

The framework progresses the state machine through the scenario. In some embodiments, the method 100 includes identifying a log event in the trace file based on the state machine at 112. In some embodiments, as described herein, regex is used to match each log event, and the configuration file can optionally define new values for variables to be extracted by regex from the log event. For example, regex provides one or more search and/or parsing functions to match each log event. In some embodiments, other search and/or parsing syntaxes are used based on the programming language. The new values allow each subtask within the scenario to be associated with adjacent subtasks in the scenario to maintain continuity.

The framework provides a decision tree of the scenarios in which the state machine for each scenario includes an or gate or an and gate. The decision tree of the scenario allows the scenario to move to the next event in the scenario based on the satisfaction of any one of the checks in the event or based on the satisfaction of any all of the checks in the event.

The method 100 further includes reporting a state machine result of the log event at 114. In some embodiments, the state machine result is the same as the log event result identified in the trace file. In some examples, the log event result is a failure, and the state machine result of searching and identifying the log event is a failure of the subtask. In other examples, the state machine result is different from the log event result, such as a state machine result that reports the state machine was unable to identify the log event result or unable to complete the scenario or portion of the scenario within the timeout conditions. In some embodiments, the framework reports the state machine result on a display of the computing device, such as in a command prompt used to interact with the framework. In other embodiments, the framework reports the state machine results by causing the result to be displayed on a display. For example, the framework selects a destination for the state machine results based at least partially on the state machine results to automatically route the state machine results and associated diagnostic information to an appropriate service technician, service center, or other user(s). In some examples, the framework reports the state machine results by causing the result to be displayed on a remote display such as via an email, direct message, update to a cloud file or database, etc.

In some embodiments, reporting the state machine result includes reporting incomplete active state machines. As described, state machines are defined as active until the state machine completes the scenario, either through a success, a failure, a restart, or other complete state. In some embodiments, when the state machine completes the scenario, the framework defines the state machine as finished and remove the state machine from the active state machines definition. In some embodiments, a state machine will remain active if the state machine is unable to complete the scenario for any reason. In some embodiments, reporting the state machine result includes reporting finished state machines with a completion status which includes success, failure, restart, or other finished status.

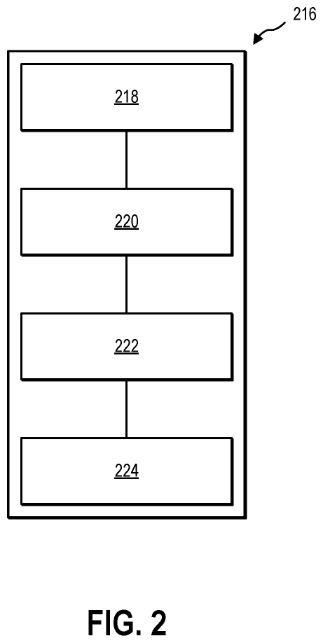

FIG. 2 illustrates portions of an embodiment of the extensible framework 216 according to the present disclosure. In some embodiments, the framework 216 includes an initialization portion 218 that defines one or more variables based on preset variable values read from user inputs. The initialization portion 218 further defines scenarios from the config file before defining a set of active state machines and finished state machines, where the active state machines include the state machines created based on the read scenarios and variables, while the finished state machines set is empty upon initialization.

In some embodiments, the initialization portion 218 includes implementation code configured to read a set of initial variables, such as those described herein, and at least one scenario from an obtained configuration file. The initialization portion 218, in some embodiments, activates at least one state machine based at least partially on the scenario(s) read from the configuration file. In some embodiments, the initialization portion 218 initializes a variable defining finished state machines to be zero or empty in preparation for the completion of one or more of the state machines.

The framework 216, in some embodiments, further includes a state machine portion 220 that instructs the state machine to search the trace file for variable matches, such as using regex. The framework remains at the state machine portion as the state machines controlled by the scenario(s) of the config file iterate through the subtasks and confirm the status of the subtasks and/or other operations based on the variables.

In some embodiments, the state machine portion 220 includes implementation code configured to iterate through the variables. In some embodiments, the state machine iterates through the tasks of the scenario and confirms the status of the tasks before confirming the status of any subtasks thereof. In some embodiments, the state machine iterates through the subtasks of a task that has failed. In at least one embodiment, the state machine iterates through each log line of the trace file in sequence.

Upon completion of one or more state machines, in some embodiments, the framework 216 includes a finishing portion 222 and a reporting portion 224. The finishing portion 222 checks for the status of the state machines in the scenario and whether the state machines are in a completed state. When the state machine is in a success, failure, restart, or other completed state (such as a clone state), the state machine value associated with the respective state machine is added to the finished state machine set and removed from the active state machines set.

In some embodiments, the finishing portion 222 includes implementation code configured to determine if a status of a state machine is successful. When the status of the state machine is successful, the finishing portion adds the state machine value to a variable including successful state machines and to a variable including finished state machines and removes the state machine value from the active state machines variable. In some embodiments, the finishing portion 222 includes implementation code configured to determine if a status of a state machine is failed. When the status of the state machine is failed or failure, the finishing portion adds the state machine value to a variable including failed state machines and to a variable including finished state machines and removes the state machine value from the active state machines variable. In some embodiments, the finishing portion 222 includes implementation code configured to determine if a status of a state machine indicates the state machine has restarted. When the status of the state machine indicates the state machine has restarted, the finishing portion adds the state machine value to a variable including successful state machines and to a variable including finished state machines and removes the state machine value from the active state machines variable. The finishing portion then adds the state machine value to a variable indicating a newly created state machine that is cloned from the restarted state machine with the state machine variable associated therewith.

In some embodiments, the reporting portion 224 instructs the console to display the state of the state machines, which reports whether a state machine is still active due to failing to complete the scenario or whether a state machine is complete. In some embodiments, the reporting portion 224 further displays whether the finished state machine succeeded, failed, restarted, etc. and what the last known state of the state machine is. The reporting portion 224 also displays to the user the last known state of any active state machines.

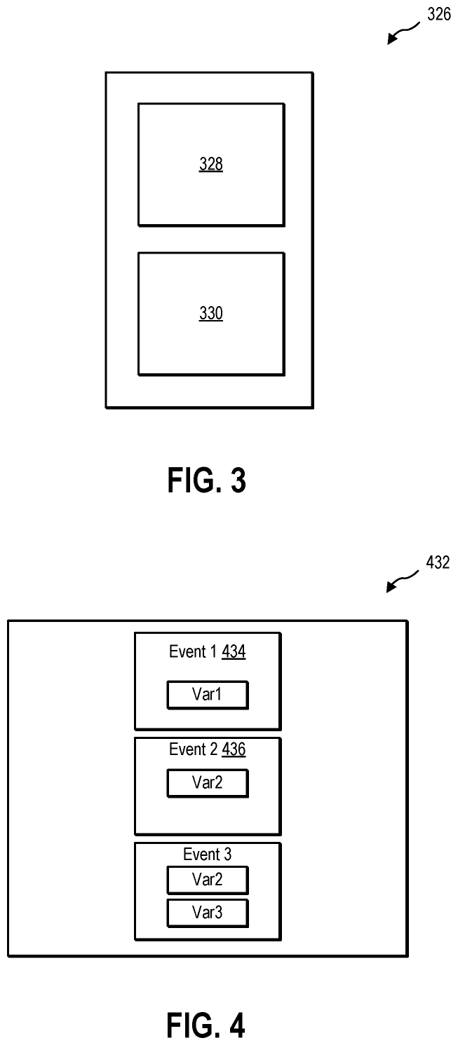

FIG. 3 illustrates a portion of an embodiment of a config file 326 read by a framework, such as a framework according to the framework 216 described in relation to FIG. 2. In the config file 326 of FIG. 3, scenario ‘a’ is successful when processing the event logs matching the event name (e.g., a nic_name) and the address (e.g., a mac address or other location) designated in the config file.

The config file 326 enables the scenario a, and the framework implements a state machine for the scenario a. In the illustrated config file 326, the state machine created by the scenario a of the config file identifies a match for event 1 with a regex (or another parsing and/or searching function), and the state machine then reads the optional variables array in the first subtask portion 328. In some embodiments, there are two variables in this example, an event name (e.g., nic_name) and a location (e.g., mac_addr), defined. In some embodiments, the variables, initially, do not have a value assigned to them, so upon successful extraction of the value of the variables from the first subtask portion 328 (using the variable regex) the values are assigned to variables. The state machine's state is updated to now match for the second subtask portion 330.

In some embodiments, upon getting the second subtask portion 330 match, the values for the specified variables for the second event are extracted. The second subtask portion 330 uses the regex provided, and in some embodiments, the regex of the second subtask portion 330 is different from the previous regex of the first subtask portion 328 for the same variable. For example, the second event log entry may be formatted differently. In the second subtask portion 330, both variables, already have values assigned to them, and the values are now compared. A match of the second subtask portion 330 can only happen if these variables' values are identical.

Note that the framework could optionally be started with pre-assigned values to each variable. This is useful in the case of targeted diagnostics when the user is only interested in an issue pertaining to a specific variable value.

To prevent bad config files or instructions from being deployed, the framework, in some embodiments, checks the dependency of the variable in the scenario to make sure variables are tied together so no accidental matching with other instances of the same event sequence can happen. For example, FIG. 4 is an example config file 432 that is rejected by the framework or other instructions because the first event 434 and the second event 436 are not dependent on one another.

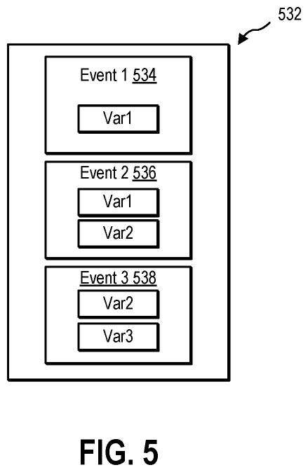

In the example of FIG. 4, var1 is not linked with (e.g., is independent of) var2 and var3. It should be noted that, in the example of FIG. 4, the values of the variables are not preset. If the values were preset, the values could be related. However, with no pre-assigned values for variable, the config file would include an event that links var1 to var2 and var3. In some embodiments, the config illustrated in FIG. 5 is, for example, is acceptable and provides the desired functionality.

The config file 532 of FIG. 5 outlines a first event 534, a second event 536, and a third event 538 that are performed sequentially. The first event 534 defines var1 before the state machine iterates to the second event 536. The second event, in contrast to the config described in relation to FIG. 4, checks var1 before defining var2. Similarly, after the second event 536, the state machine iterates to the third event 538 which checks var2 before defining var3.

In some embodiments, a verification schema, such as a JSON schema, is used to check the validity of the config file or scenarios therein prior to the implementation of a state machine for the scenario.

In at least one embodiment, the framework times out waiting for config to finish. The framework reports the timeout event, e.g., to inform a user of the timeout event. In some embodiments, the config file includes a plurality of scenarios, and the framework is unable to identify the scenario that caused the timeout event. In such embodiments, each scenario in the config includes a timeout value, allowing the framework to identify the scenario causing the timeout event through the reporting of the state machine status.

In some embodiments, a scenario of the config exceeds a timeout value in the config. The framework reports the timeout event to inform a user of the timeout event. However, in some embodiments, the config and/or the framework enables a second scenario with at least one of the same events therein, with a timeout value assigned for at least the one event or for all events within the scenario. For example, the second scenario is enabled upon the timeout event of the first scenario, and the second scenario repeats at least some of the events of the first scenario while further measuring and report timeout events for the individual events. In some embodiments, the config file and/or framework, therefore, identifies and/or diagnoses the specific event within the scenario that is causing the timeout condition.

Embodiments according to the present disclosure may include or be a system, a method, and/or a computer program product. In some embodiments, the computer program product includes a computer readable storage medium (or media) having computer readable instructions stored thereon for causing a processor to perform at least a portion of one or more methods described herein.

The computer readable storage medium can be a tangible device (e.g., non-transitory) that can retain and store instructions for use by an instruction execution device. The computer readable storage medium may be, for example, an electronic storage device, a magnetic storage device, an optical storage device, an electromagnetic storage device, a semiconductor storage device, or any suitable combination of the foregoing. Examples of the computer readable storage medium include the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In some embodiments, the network comprises electrical transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present disclosure include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server to allow remote diagnostics. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) executes the computer readable program instructions by utilizing state information of the computer readable program instructions to control the electronic circuitry.

### INDUSTRIAL APPLICABILITY

The present disclosure generally relates to systems and methods for automatic diagnosis of complex computer systems. More particularly, the present disclosure relates to an extensible framework to diagnosis a failure or timeout of one or more subtasks within a complex system. For example, complex components and/or systems such as kernel-mode components perform scenario operations that include many subtasks, which are either sequentially performed and dependent on one another or concurrently performed and independent of one another. Such complex scenario operations can be difficult or nearly impossible to diagnose in real-time as identifying the individual subtask success or failure cannot be performed in real-time.

In some embodiments, the computing system generates a trace file for the scenario and/or component including the scenario. The scenario and/or component including the scenario includes one or more tasks for the computing system to perform. The trace file is generated by the computing system upon a failure of a task (or subtask of a task) of the scenario, and the trace file can include records of thousands of operations, threads, or other computational functions that, while reporting the results of the scenarios and subtasks, can obfuscate the outputs. Further, the trace files can include all operations performed by the system, which may include a variety of types of operations (network communication, virtual machine implementation, hardware controllers, etc.) and/or log events for operations in a non-linear order, impairing the ability for any single user, such as an engineer, service specialist, technician, customer, etc. to interpret all of the different operation types and subtasks associated with a scenario. An extensible framework according to the present disclosure provides an automated tool for identifying a failure of a subtask within a scenario of a complex system, reporting the failure in a human-readable format, and, in some embodiments, directing a report to an appropriate engineer or engineering group.

In a conventional simple system within a computing system without concurrent or parallel processes, a failure or one or more events of the simple system is logged in one or more lines of an event log. Diagnosing the event may include reading the event log to identify the point in the simple system that caused the failure. In a complex system, parallel operations and complex interactions between scenarios and subtasks can produce a trace file that, while including a record of the failed or incomplete operation, may be not readable or understandable to a user. For example, during virtual machine creation in a datacenter, many systems are operating in parallel to establish both software and hardware controls. An operation failure during the virtual machine creation may be difficult or impossible to identify and a user may be unable to diagnose a root cause of the failure using existing diagnostic tools. Further, in some instances, analysis of and/or diagnosis of some operating systems or other low-level complex systems require kernel mode and/or are non-extensible, limiting the scalability and deployability of new scenarios and new diagnostic tools.

In some embodiments, an extensible framework for automatic complex system diagnostics according to the present disclosure is a framework that reads one or more configuration files (“config files”) which describe different scenarios as decision trees of trace events recorded in a trace file. The framework implements one or more state machines based on the scenario(s) of the config file and preset variables. The state machine(s) then parse the trace file to match variables with the trace events of the trace file. Matching variables with the trace events of the trace file can allow the state machines to iterate through the subtasks of the scenario and identify the root cause of the failure.

For example, if Trace Event A is detected in the trace file for Scenario A′ then the framework expects events B through N to have occurred and be present in the trace file for Scenario A′ to be successful. The framework will iterate through the expected events of the scenario (based at least partially on the config file) in an attempt to match identifying values for the expected events of the scenario. In the instance that the framework is unable to match identifying values for the expected events of the scenario, the framework returns an error for the scenario and/or identify which subtask event caused the failure. In some examples, the framework identifies explicit errors in the trace file for the trace events associated with the identifying values. In such examples, the framework returns an error for the scenario and/or identifies which subtask event caused the failure. For example, a report is provided, where the report indicates the scenario or subtask associated with the failure. Thereby, a user is directly informed that a certain subtask or scenario has failed or not been executed.

In some embodiments, the config file is a human-readable structured file. In some examples, a human-readable structured file allows a user to add new entries to the config file as issues arise and are identified, or as new features are added to components of the system. Because the framework receives scenarios and implements state machines based at least partially on the config file, different config files allow the framework to be adapted to a variety of diagnostic needs for a variety of systems. Embodiments of config files described herein will provide examples of specific diagnostic needs but should be understood as examples.

In some embodiments, a method of providing a framework for automated diagnosis of a complex system includes obtaining a trace file and obtaining a config file. In some embodiments, the framework is provided by or within an operating system of a computing device. In some embodiments, the framework is stored locally on a hardware storage device on the computing device. In some embodiments, the framework is obtained by the computing device from a remote hardware storage device, such as via a network.

The trace file is, in some embodiments, generated by the application, the operating system, or another complex system to report one or more failed or incomplete tasks. For example, upon a request failing or generating an error, a user is presented with the trace file to diagnose the error. In some embodiments, the trace file is generated independently of whether there was a failed or incomplete task. In at least one embodiment, the trace file is a plain text file, which is able to be parsed through regular expressions (regex). For example, the trace file is a onetrace.txt file, and the regex parsing allows the framework to identify strings within the onetrace.txt file based on the config file obtained.

In some embodiments, the user provides a config file to the framework, such as in a console command, and the config file is stored locally on a hardware storage device on the computing device. In some embodiments, the config file is obtained by the computing device from a remote hardware storage device, such as via a network. The config file provided to the framework is, in some embodiments, related to the error that caused the trace file. In other embodiments, the config file instructs the framework to identify values for variables based on the trace file and events therein to diagnose the failed subtasks of the scenario.

In some embodiments, the config file is written in a human-readable structure, such as Yet Another Markup Language (“YAML”). A human-readable language and/or structure allows the config file to be customized, modified, or simply understood by a technician or other user. For example, the config file includes comments therein to inform a user of operations performed by or requested by the config file.

The method further includes identifying a scenario in the configuration file with the framework. A scenario is an operation of the computing device (e.g., of the operation system, subsystem, or application stored thereon) that includes a plurality of subtasks managed or coordinated by the scenario. In some embodiments, the framework reads the config file to identify at least one scenario in the config file. In some embodiments, the config file includes a plurality of scenarios. In some embodiments, one or more of the scenarios is enabled upon initial reading of the config file, and, in some embodiments, one or more of the scenarios is disabled upon initial reading of the config file. In some embodiments, during execution of the config file by the framework, a scenario that is initially disabled is enabled based upon the results of another scenario. For example, if a first scenario produces a particular output, a second scenario is enabled, and the framework performs at least a portion of the second scenario in response to the output of the first scenario. In at least one example, if a first scenario exceeds a timeout value, the second scenario is enabled in response to the first scenario timing out.

The method further includes implementing at least one state machine based at least partially on the at least one scenario and at least one variable. In some embodiments, implementing the framework includes creating one or more state machines based on the scenario and initial variables. For example, the framework defines one or more variables and read preset values for the one or more variables. In some embodiments, a user provides the preset values for the one or more variables, and the framework reads the preset values to populate at least a portion of the state machines from the scenario.

In some embodiments, the framework defines one or more of the state machine(s) as active state machines. Any state machines are defined as active until the state machine completes the scenario, either through a success, a failure, a restart, or another complete state. When the state machine completes the scenario, in some embodiments, the framework defines the state machine as finished and remove the state machine from the active state machines definition. In some embodiments, a state machine will remain active if the state machine is unable to complete the scenario for any reason.

In some embodiments, a variable is a globally unique identifier (GUID) that the user provides to at least partially identify the failed request or scenario the user desires to diagnose. In some embodiments, the variable has no assigned value upon defining the variable, and the value is assigned upon executing at least a portion of a state machine. In some embodiments, the variable is a preset variable with a value that is assigned upon defining the variable. For example, a preset variable is or includes a correlation ID that is provided for operations or processes of some complex systems. In some examples, a correlation ID is a unique identifier that is added to a first interaction (incoming request) to identify the context and is passed to all components that are involved in a transaction flow. In a particular example, some complex systems such as MICROSOFT SHAREPOINT or MICROSOFT AZURE, virtual machine operations automatically provide a correlation ID that is a GUID for every request that the server receives. In some embodiments, the correlation ID is unique to each request. When an error occurs related to the request, some embodiments of an error message contain the correlation ID that was valid for the request at the time, which is, in some embodiments, provided to the framework, and the framework uses in the scenario to identify event logs in the trace file associated with the request that generated the error and/or other processes that were occurring at the time of the error. It should be understood that the correlation ID is any tool used to associate events within the complex system. In some embodiments, a correlation ID is a ThreadID, ProcessID, timestamp, CorrelationID, or other function within the system.

The method further includes iterating the state machine through the scenario based at least partially on the trace file. In some embodiments, the framework is implemented by defining variables that do not have values upon initialization. In some embodiments, the framework initializes the state machine based at least partially on the config file and the preset variables. The config file includes a scenario with a plurality of subtasks therein. The state machine iterates through the subtasks of the scenario by parsing the trace file and matching the events identified in the scenario. As described herein, a scenario includes an expected sequence of events and/or subtasks to be performed and, therefore, recorded in the trace file. In some embodiments, the scenario includes regex commands or other parsing and/or matching commands to identify events in the trace file.

In some embodiments, the framework identifies a new value for a variable in the scenario and uses that new value in a subsequent subtask of the scenario. As will be described herein, in some embodiments, each event of a scenario identifies a variable that is associated with an immediately subsequent event, ensuring continuity of the events through the scenario for diagnostics.

As the framework implements state machines and iterates through the scenarios, in some embodiments, the framework provides sequential scenarios for diagnosing failed scenarios. In other embodiments, the framework provides parallel scenarios in the framework to allow simultaneous operations where a first scenario is independent of the output or results of a second scenario.

The framework progresses the state machine through the scenario. In some embodiments, the method includes identifying a log event in the trace file based on the state machine. In some embodiments, as described herein, regex is used to match each log event, and the configuration file can optionally define new values for variables to be extracted by regex from the log event. For example, regex provides one or more search and/or parsing functions to match each log event. In some embodiments, other search and/or parsing syntaxes are used based on the programming language. The new values allow each subtask within the scenario to be associated with adjacent subtasks in the scenario to maintain continuity.

The framework provides a decision tree of the scenarios in which the state machine for each scenario includes an or gate or an and gate. The decision tree of the scenario allows the scenario to move to the next event in the scenario based on the satisfaction of any one of the checks in the event or based on the satisfaction of any all of the checks in the event.

The method further includes reporting a state machine result of the log event. In some embodiments, the state machine result is the same as the log event result identified in the trace file. In some examples, the log event result is a failure, and the state machine result of searching and identifying the log event is a failure of the subtask. In other examples, the state machine result is different from the log event result, such as a state machine result that reports the state machine was unable to identify the log event result or unable to complete the scenario or portion of the scenario within the timeout conditions. In some embodiments, the framework reports the state machine result on a display of the computing device, such as in a command prompt used to interact with the framework. In other embodiments, the framework reports the state machine results by causing the result to be displayed on a display. For example, the framework selects a destination for the state machine results based at least partially on the state machine results to automatically route the state machine results and associated diagnostic information to an appropriate service technician, service center, or other user(s). In some examples, the framework reports the state machine results by causing the result to be displayed on a remote display such as via an email, direct message, update to a cloud file or database, etc.

In some embodiments, reporting the state machine result includes reporting incomplete active state machines. As described, state machines are defined as active until the state machine completes the scenario, either through a success, a failure, a restart, or other complete state. In some embodiments, when the state machine completes the scenario, the framework defines the state machine as finished and remove the state machine from the active state machines definition. In some embodiments, a state machine will remain active if the state machine is unable to complete the scenario for any reason. In some embodiments, reporting the state machine result includes reporting finished state machines with a completion status which includes success, failure, restart, or other finished status.

In some embodiments, the framework includes an initialization portion that defines one or more variables based on preset variable values read from user inputs. The initialization portion further defines scenarios from the config file before defining a set of active state machines and finished state machines, where the active state machines include the state machines created based on the read scenarios and variables, while the finished state machines set is empty upon initialization.

In some embodiments, the initialization portion includes implementation code configured to read a set of initial variables, such as those described herein, and at least one scenario from an obtained configuration file. The initialization portion, in some embodiments, activates at least one state machine based at least partially on the scenario(s) read from the configuration file. In some embodiments, the initialization portion initializes a variable defining finished state machines to be zero or empty in preparation for the completion of one or more of the state machines.

The framework, in some embodiments, further includes a state machine portion that instructs the state machine to search the trace file for variable matches, such as using regex. The framework remains at the state machine portion as the state machines controlled by the scenario(s) of the config file iterate through the subtasks and confirm the status of the subtasks and/or other operations based on the variables.

In some embodiments, the state machine portion includes implementation code configured to iterate through the variables. In some embodiments, the state machine iterates through the tasks of the scenario and confirms the status of the tasks before confirming the status of any subtasks thereof. In some embodiments, the state machine iterates through the subtasks of a task that has failed. In at least one embodiment, the state machine iterates through each log line of the trace file in sequence.

Upon completion of one or more state machines, in some embodiments, the framework includes a finishing portion and a reporting portion. The finishing portion checks for the status of the state machines in the scenario and whether the state machines are in a completed state. When the state machine is in a success, failure, restart, or other completed state (such as a clone state), the state machine value associated with the respective state machine is added to the finished state machine set and removed from the active state machines set.

In some embodiments, the finishing portion includes implementation code configured to determine if a status of a state machine is final and/or successful. When the status of the state machine is final and/or successful, the finishing portion adds the state machine value to a variable including successful state machines and to a variable including finished state machines and removes the state machine value from the active state machines variable. In some embodiments, the finishing portion includes implementation code configured to determine if a status of a state machine is failed or failure. When the status of the state machine is failed or failure, the finishing portion adds the state machine value to a variable including failed state machines and to a variable including finished state machines and removes the state machine value from the active state machines variable. In some embodiments, the finishing portion includes implementation code configured to determine if a status of a state machine indicates the state machine has restarted. When the status of the state machine indicates the state machine has restarted, the finishing portion adds the state machine value to a variable including successful state machines and to a variable including finished state machines and removes the state machine value from the active state machines variable. The finishing portion then adds the state machine value to a variable indicating a newly created state machine that is cloned from the restarted state machine with the state machine variable associated therewith.

In some embodiments, the reporting portion instructs the console to display the state of the state machines, which reports whether a state machine is still active due to failing to complete the scenario or whether a state machine is complete. In some embodiments, the reporting portion further displays whether the finished state machine succeeded, failed, restarted, etc. and what the last known state of the state machine is. The reporting portion also displays to the user the last known state of any active state machines.

In some embodiments, a config file includes one or more scenarios. In one example, scenario ‘a’ is successful when processing the event logs matching the event name (e.g., a nic_name) and the address (e.g., a mac address or other location) designated in the config file.

The config file enables the scenario a, and the framework implements a state machine for the scenario a. In such a config file, the state machine created by the scenario a of the config file identifies a match for a first event with a regex (or another parsing and/or searching function), and the state machine then reads the optional variables array in a first subtask portion. In some examples, there are two variables, an event name (e.g., nic_name) and a location (e.g., mac_addr), defined. In some embodiments, the variables, initially, do not have a value assigned to them, so upon successful extraction of the value of the variables from the first subtask portion (using the variable regex) the values are assigned to variables. The state machine's state is updated to now match for a second subtask portion.

In some embodiments, upon getting the second subtask portion 330 match, the values for the specified variables for the second event are extracted. The second subtask portion uses the regex provided, and in some embodiments, the regex of the second subtask portion is different from the previous regex of the first subtask portion for the same variable. For example, the second event log entry may be formatted differently. In the second subtask portion, both variables, already have values assigned to them, and the values are now compared. A match of the second subtask portion happens if these variables' values are identical.

Note that the framework could optionally be started with pre-assigned values to each variable. This is useful in the case of targeted diagnostics when the user is only interested in an issue pertaining to a specific variable value.

To prevent bad config files or instructions from being deployed, the framework, in some embodiments, checks the dependency of the variable in the scenario to make sure variables are tied together so no accidental matching with other instances of the same event sequence can happen. In some examples, a config file is rejected by the framework or other instructions because a first event and a second event are not dependent on one another.

For example, a first variable (var1) of the first event is not linked with (e.g., independent of) a second variable (var2) of the second event and a third variable (var3) of a third event. In some examples, the values of the variables are not preset. If the values are preset, the values could be related. However, with no pre-assigned values for variable, the config file would include an event that links var1 to var2 and var3.

In some embodiments, a valid config file outlines a first event, a second event, and a third event that are performed sequentially. The first event defines var1 before the state machine iterates to the second event. The second event, in contrast to the invalid config file described above, checks var1 before defining var2. Similarly, after the second event, the state machine iterates to the third event 53 which checks var2 before defining var3. The three events are therefore dependent on one another, and the config file is determined to be valid prior to the framework implementing state machines based on the config file.

In some embodiments, a verification schema, such as a JSON schema, is used to check the validity of the config file or scenarios therein prior to the implementation of a state machine for the scenario.

In at least one embodiment, the framework times out waiting for config to finish. The framework reports the timeout event, e.g., to inform a user of the timeout event. In some embodiments, the config file includes a plurality of scenarios, and the framework is unable to identify the scenario that caused the timeout event. In such embodiments, each scenario in the config includes a timeout value, allowing the framework to identify the scenario causing the timeout event through the reporting of the state machine status.

In some embodiments, a scenario of the config exceeds a timeout value in the config. The framework reports the timeout event to inform a user of the timeout event. However, in some embodiments, the config and/or the framework enables a second scenario with at least one of the same events therein, with a timeout value assigned for at least the one event or for all events within the scenario. For example, the second scenario is enabled upon the timeout event of the first scenario, and the second scenario repeats at least some of the events of the first scenario while further measuring and report timeout events for the individual events. In some embodiments, the config file and/or framework, therefore, identifies and/or diagnoses the specific event within the scenario that is causing the timeout condition.

Embodiments according to the present disclosure may include or be a system, a method, and/or a computer program product. In some embodiments, the computer program product includes a computer readable storage medium (or media) having computer readable instructions stored thereon for causing a processor to perform at least a portion of one or more methods described herein.

The computer readable storage medium can be a tangible device (e.g., non-transitory) that can retain and store instructions for use by an instruction execution device. The computer readable storage medium may be, for example, an electronic storage device, a magnetic storage device, an optical storage device, an electromagnetic storage device, a semiconductor storage device, or any suitable combination of the foregoing. Examples of the computer readable storage medium include the following: a portable computer diskette, a hard disk, a random-access memory (RAM), a read-only memory (ROM), an erasable programmable read-only memory (EPROM or Flash memory), a static random-access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. In some embodiments, the network comprises electrical transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations of the present disclosure include assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server to allow remote diagnostics. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) executes the computer readable program instructions by utilizing state information of the computer readable program instructions to control the electronic circuitry.

The present disclosure relates to systems and methods for automatically diagnosing event failures in a complex system according to at least the examples provided in the sections below:
[A1] In some embodiments, a method includes obtaining a trace file, identifying a scenario in a configuration file, implementing a state machine for the scenario, iterating the state machine through the scenario based at least partially on values obtained from the trace file, identifying a log event in the trace file based on the state machine, and reporting a state machine result of the log event.
[A2] In some embodiments, the method of [A1] further includes a timeout status for the state machine that reports a timeout result when the scenario exceeds a timeout value.
[A3] In some embodiments, the scenario of [A1] or [A2] includes a plurality of subtasks and iterating the state machine through the scenario includes iterating through the plurality of subtasks.
[A4] In some embodiments, the method of [A3] further includes a timeout status for the state machine that reports a timeout result when a subtask exceeds a timeout value.
[A5] In some embodiments, the method of [A4] wherein a first timeout status is associated with a first subtask of the scenario and a second timeout status is associated with a second subtask of the scenario.
[A6] In some embodiments, iterating through the plurality of subtasks of [A3] includes comparing at least one result of at least one of the plurality of subtasks.
[A7] In some embodiments, the configuration file of any of [A1] through [A6] is a plain text file.
[A8] In some embodiments, the method of any of [A1] through [A7] further includes validating the configuration file with a schema.
[A9] In some embodiments, the configuration file of [A8] includes a first subtask and a second subtask and validating the configuration file includes confirming a dependency of a variable in the second subtask to the variable in the first subtask.
[A10] In some embodiments, the method of any of [A1] through [A9] further includes parsing the trace file based at least partially on an initial state of the state machine and defining at least one variables of the state machine based at least partially on a value from the trace file.
[A11] In some embodiments, the at least one variable of [A10] is a globally unique identifier (GUID).
[A12] In some embodiments, the method of [A11] further includes obtaining an initial GUID value of the trace file before implementing the state machine and defining the at least one variable includes comparing the value from the trace file to the initial GUID value.
[A13] In some embodiments, the method of any of [A1] through [A11] further includes defining a list of active state machines based at least partially on the scenario identified.
[A14] In some embodiments, after iterating the state machine through the scenario, the method of [A13] includes removing the state machine from the list of active state machines and reporting the state machine as complete with the state machine result.
[A15] In some embodiments, after iterating the state machine through a portion of the scenario, the method of [A13] includes identifying at least one failed subtask and reporting the state machine as incomplete with a state associated with the at least one failed subtask.
[B1] In some embodiments, a system includes a processor and a computer readable media (CRM). The CRM includes instructions stored thereon that, when executed by the processor, cause the system to obtain a trace file, obtain a configuration file, identify a first scenario in the configuration file including a first plurality of subtasks, implement a first state machine for the first scenario, iterate the state machine through the first scenario based at least partially on the trace file, exceed a timeout value associated with the first scenario, identify a second scenario including a second plurality of subtasks, implement a second state machine for the second scenario, and report a timeout event for at least one subtask of the second plurality of subtasks of the second state machine.
[B2] In some embodiments, the first plurality of subtasks and second plurality of subtasks of [B1] are the same.
[B3] In some embodiments, reporting a timeout event for at least one subtask of the second plurality of subtasks of the second state machine of [B1] or [B2] further comprises reporting a status for each subtask of the second plurality of subtasks.
[C1] In some embodiments, a non-transitory computer readable media (CRM) includes instructions stored thereon. The instructions, when executed by a processor, cause the processor to obtain a trace file, obtain a configuration file, identify a scenario in the configuration file, implement a state machine for the scenario, iterate the state machine through the scenario based at least partially on values obtained from the trace file, identify a log event in the trace file based on the state machine, and report a state machine result of the log event.
[C2] In some embodiments, the non-transitory CRM of [C1] includes the configuration file.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method comprising:
obtaining a trace file;
identifying a scenario in a configuration file;
implementing a state machine for the scenario;
identifying a log event in the trace file by iterating the state machine through the scenario based at least partially on values obtained from the trace file; and
reporting a state machine result of the log event.

2. The method of claim 1, wherein the state machine includes a timeout status that reports a timeout result in response to the scenario exceeding a timeout value.

3. The method of claim 1, wherein the scenario includes a plurality of subtasks and iterating the state machine through the scenario includes iterating through the plurality of subtasks.

4. The method of claim 3, wherein the state machine includes a timeout status that reports a timeout result in response to a subtask exceeding a timeout value.

5. The method of claim 3, wherein a first timeout status is associated with a first subtask of the plurality of subtasks and a second timeout status is associated with a second subtask of the plurality of subtasks.

6. The method of claim 3, wherein iterating through the plurality of subtasks includes comparing a result of a first subtask of the plurality of subtasks to a result of a second subtask of the plurality of subtasks.

7. The method of claim 1, wherein the configuration file is a plain text file.

8. The method of claim 1, further comprising validating the configuration file with a schema.

9. The method of claim 8, wherein the configuration file includes a first subtask and a second subtask and validating the configuration file includes confirming a dependency of a variable in the second subtask to the variable in the first subtask.

10. The method of claim 1, further comprising parsing the trace file based at least partially on an initial state of the state machine and defining a variable of the state machine based at least partially on a value from the trace file.

11. The method of claim 10, wherein the variable is a globally unique identifier (GUID).

12. The method of claim 11, further comprising obtaining an initial GUID value of the trace file before implementing the state machine,
wherein defining the variable includes comparing the value from the trace file to the initial GUID value.

13. The method of claim 1, further comprising defining a list of active state machines based at least partially on the scenario.

14. The method of claim 13, after iterating the state machine through the scenario, removing the state machine from the list of active state machines and reporting the state machine as complete with the state machine result.

15. The method of claim 13, after iterating the state machine through a portion of the scenario, identifying a failed subtask and reporting the state machine as incomplete with a state associated with the failed subtask.

16. A system comprising:
a processing system comprising a processor;
a computer readable storage medium in data communication with the processing system, the hardware storage device having computer readable instructions stored thereon that, when executed by the processing system, cause the system to:
obtain a trace file;
obtain a configuration file;
identify a first scenario in the configuration file including a first plurality of subtasks;
implement a first state machine for the first scenario;
iterate the state machine through the first scenario based at least partially on the trace file;
exceed a timeout value associated with the first scenario;
identify a second scenario including a second plurality of subtasks;
implement a second state machine for the second scenario; and
report a timeout event for a subtask of the second plurality of subtasks of the second state machine.

17. The system of claim 16, wherein the first plurality of subtasks and second plurality of subtasks are the same.

18. The system of claim 16, wherein reporting a timeout event for the subtask of the second plurality of subtasks of the second state machine further comprises reporting a status for each subtask of the second plurality of subtasks.

19. A non-transitory computer readable media (CRM), the CRM having instructions stored thereon that, when executed by a processing system, cause the processing system to perform a method comprising:
obtain a trace file;
obtain a configuration file;
identify a scenario in the configuration file;
implement a state machine for the scenario;
iterate the state machine through the scenario based at least partially on values obtained from the trace file;
identify a log event in the trace file based on the state machine; and
report a state machine result of the log event.

20. The non-transitory CRM of claim 19, wherein the non-transitory CRM further includes the configuration file.
